(19) United States
(12) Patent Application Publication
(10) Pub. No.: US 2026/0329793 A1
(43) Pub. Date: Oct. 22, 2026

(54) METHOD FOR DESIGNING PORT IMPEDANCE CIRCUIT, CIRCUIT, AND SYSTEM

(71) Applicant: Beijing Youzhuju Network Technology Co., Ltd., Beijing (CN)

(72) Inventors: Hanxiao DU, Beijing (CN); Junyan GUO, Beijing (CN); Jian WANG, Beijing (CN)

(21) Appl. No.: 19/414,881

(22) Filed: Dec. 10, 2025

(30) Foreign Application Priority Data
Apr. 22, 2025 (CN) 202510511689.2

(51) Int. Cl. G06F 13/38

(52) U.S. Cl. CPC G06F 13/382; G06F 2213/38

(57) ABSTRACT

A method for designing a port impedance circuit, a circuit, and a system are provided. The method includes: performing, internal impedance calibration by using an external resistor; and selecting a first number of impedance units to be connected in parallel at the receive port, and selecting a second number of the impedance units to be connected in parallel at the transmit port. An impedance value of each of the impedance units is equal to a positive-integer multiple of an impedance value of the external resistor, the impedance value of each of the impedance units divided by the first number is equivalent to the input impedance value of the receive port, and the impedance value of each of the impedance units divided by the second number is equivalent to the output impedance value of the transmit port.

### CROSS REFERENCE

The present disclosure claims to priority to Chinese invention application 202510511689.2 filed on Apr. 22, 2025 titled “PORT IMPEDANCE CIRCUIT DESIGN METHOD, CIRCUIT, AND SYSTEM”, which is in incorporated herein by reference in its entirety.

### TECHNICAL FIELD

Embodiments of the present disclosure relate to the field of chip technologies, and in particular, to a method for designing a port impedance circuit and circuit, and a system.

### BACKGROUND

UCIe (Universal Chiplet Interconnect Express) is an open industry standard interconnection protocol. A transmit port of the UCIe is referred to as a transmitter (TX), and a receive port of the UCIe is referred to as a receiver (RX). Similar to TX/RX of other interface protocols such as a serializer/deserializer (SerDes) or a Peripheral Component Interconnect Express (PCIe), the UCIe also has a design requirement for port impedance. However, a specification (spec) of the UCIe does not determine a specific design of impedance circuits of the transmit port and the receive port of the UCIe. Therefore, how to implement the design of the impedance circuits of the transmit port and the receive port of the UCIe becomes an urgent technical problem to be solved.

### SUMMARY

In view of this, embodiments of the present disclosure provide a port impedance circuit design method and circuit, and a system to at least solve or alleviate the above problems.

According to a first aspect of an embodiment of the present disclosure, a method for designing a port impedance circuit is provide, the port impedance circuit being applied to a UCIe. The method includes: setting an input impedance value of a receive port, setting an output impedance value of a transmit port, and performing, by an impedance calibration circuit, internal impedance calibration by using an external resistor; and reusing, by the receive port, an impedance circuit of the transmit port, selecting a first number of impedance units to be connected in parallel at the receive port, and selecting a second number of the impedance units to be connected in parallel at the transmit port, wherein an impedance value of each of the impedance units is equal to a positive-integer multiple of an impedance value of the external resistor the impedance value of each of the impedance units divided by the first number is equivalent to the input impedance value of the receive port, and the impedance value of each of the impedance units divided by the second number is equivalent to the output impedance value of the transmit port.

According to a second aspect of an embodiment of the present disclosure, there is provided a port impedance circuit, applied to UCIe, where the port impedance circuit is coupled to a transmit port and a receive port; an impedance calibration circuit of the port impedance circuit performs internal impedance calibration by using an external resistor; and the port impedance circuit enables the receive port to reus an impedance circuit of the transmit port, selects a first number of impedance units to be connected in parallel at the receive port as a receive port impedance circuit, and selects a second number of the impedance units to be connected in parallel at the transmit port as a transmit port impedance circuit, where an impedance value of each of the impedance units is equal to a positive-integer multiple of an impedance value of the external resistor, the impedance value of each of the impedance units divided by the first number is equivalent to an input impedance value of the receive port, and the impedance value of each of the impedance units divided by the second number is equivalent to an output impedance value of the transmit port.

According to a third aspect of an embodiment of the present disclosure, there is provided a system, including the port impedance circuit according to the second aspect and a chip, where a transmit port and a receive port of the chip are coupled to the port impedance circuit.

According to the port impedance circuit design solution provided in this embodiment of the present disclosure, the input impedance value of the receive port and the output impedance value of the transmit port are set, and the impedance calibration circuit performs the internal impedance calibration by using the external resistor. In this embodiment of the present disclosure, the receive port reuses the impedance circuit of the transmit port. The first number of impedance units are selected to be connected in parallel at the receive port, and the second number of the impedance units are selected to be connected in parallel at the transmit port. The impedance value of each of the impedance units is equal to the positive-integer multiple of the impedance value of the external resistor. The impedance value of each of the impedance units divided by the first number is equivalent to the input impedance value of the receive port. The impedance value of each of the impedance units divided by the second number is equivalent to the output impedance value of the transmit port. This embodiment of the present disclosure implements the design of the impedance circuits of the transmit port and the receive port of the UCIe, and has a simple circuit design, and improves design consistency.

### BRIEF DESCRIPTION OF THE DRAWINGS

In order to more clearly describe the technical solutions in the embodiments of the present disclosure or in the prior art, the following briefly introduces the drawings required for describing the embodiments or the prior art. Apparently, the drawings in the following description show merely some embodiments described in the embodiments of the present disclosure, and a person of ordinary skill in the art may still derive other drawings from these drawings.

FIG. 1 is a flowchart of a port impedance circuit design method according to an embodiment of the present disclosure;

FIG. 2 is a flowchart of a port impedance circuit design method according to another embodiment of the present disclosure;

FIG. 3a shows an impedance unit structure recommended in a specification of a UCIe;

FIG. 3b shows an actual circuit architecture of the impedance unit structure recommended in the specification of the UCIe;

FIG. 4a and FIG. 4b are schematic diagrams of a port impedance circuit according to still another embodiment of the present disclosure;

FIG. 5 is a schematic diagram of an equivalent impedance of a port impedance circuit according to still another embodiment of the present disclosure;

FIG. 6 is a schematic diagram of drive waveforms of a data input signal and a data input 1 unit interval signal of a port impedance circuit according to still another embodiment of the present disclosure;

FIG. 7 is a schematic diagram of first-stage and second-stage circuits for generating, through multiplexing half-rate parallel-to-serial conversion logic, a data input signal and a data input 1 unit interval signal of a port impedance circuit according to still another embodiment of the present disclosure; and

FIG. 8 is a schematic diagram of a specific circuit for generating a data input signal and a data input 1 unit interval signal of a port impedance circuit according to still another embodiment of the present disclosure.

### DETAILED DESCRIPTION OF EMBODIMENTS

Embodiments of the present disclosure are described in more detail below with reference to the drawings. Although some embodiments of the present disclosure are shown in the drawings, it should be understood that the present disclosure may be implemented in various forms, and should not be construed as limited to the embodiments set forth herein. Instead, these embodiments are provided for a more thorough and complete understanding of the present disclosure. It should be understood that the drawings and embodiments of the present disclosure are only for illustrative purposes, and are not intended to limit the protection scope of the present disclosure.

It should be noted that the titles of any sections/subsections provided herein are not restrictive. Various embodiments are described throughout this specification, and any type of embodiments may be included under any section/subsection. In addition, the embodiments described in any section/subsection may be combined with any other embodiments described in the same section/subsection and/or different sections/subsections in any manner.

In the description of the embodiments of the present disclosure, the term “include/comprise” and similar terms should be understood as open-ended inclusions, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. Other definitions, both explicit and implicit, may be included below. The terms “first”, “second”, and the like may refer to different or same objects. Other definitions, both explicit and implicit, may be included below.

The embodiments of the present disclosure may involve user data, data acquisition, and/or data use. These aspects comply with corresponding laws, regulations, and related provisions. In the embodiments of the present disclosure, all data collection, acquisition, processing, forwarding, and use are performed on the premise that the user knows and confirms. Correspondingly, when implementing the embodiments of the present disclosure, the user should be informed of the type, scope of use, use scenarios, etc., of data or information that may be involved, and the authorization of the user should be obtained, through appropriate means in accordance with relevant laws and regulations. The specific manner of informing and/or authorizing may vary according to the actual situation and application scenarios, and the scope of the present disclosure is not limited in this regard.

If the solutions in this specification and the embodiments involve personal information processing, the processing will be performed on the premise that there is a legal basis (for example, the consent of the personal information subject is obtained, or it is necessary for the performance of a contract, etc.), and will only be performed within the scope of regulations or agreements. If the user refuses to process personal information other than the necessary information required for the basic functions, it will not affect the user's use of the basic functions.

First, some nouns or terms that appear in the process of describing the embodiments of the present disclosure are suitable for the following explanations.

UCIe: aims to unify the interconnection interface standard between different chips (Chiplets).

FFE (Feed-Forward Equalizer): a feed-forward equalizer, which is a linear equalization technology used for signal processing. The specification (spec) of the UCIe recommends using first-order de-emphasis to implement the FFE of the transmit port, to implement equalization. The high-speed output data generated by the transmit port is artificially and logically controlled to add amplitude variation in the case of full swing, so as to improve the problem of ISI (Inter-Symbol Interference).

The port impedance circuit design solution provided in the embodiments of the present disclosure is described in detail below with reference to the drawings.

### Design Method

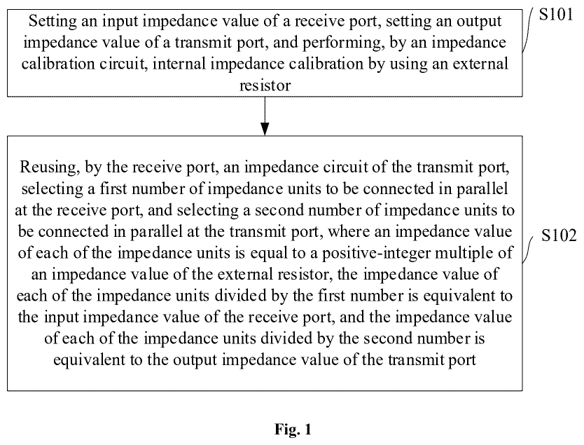

An embodiment of the present disclosure provides a port impedance circuit design method, applied to UCIe. Referring to FIG. 1, the method includes:

Step S101: setting an input impedance value of a receive port, setting an output impedance value of a transmit port, and performing, by an impedance calibration circuit, internal impedance calibration by using an external resistor.

Step S102: reusing, by the receive port, the impedance circuit of the transmit port, selecting a first number of impedance units to be connected in parallel at the receive port, and selecting a second number of the impedance units to be connected in parallel at the transmit port, where an impedance value of each of the impedance units is equal to a positive-integer multiple of an impedance value of the external resistor, the impedance value of each of the impedance units divided by the first number is equivalent to the input impedance value of the receive port, and the impedance value of each of the impedance units divided by the second number is equivalent to the output impedance value of the transmit port.

This embodiment of the present disclosure implements the design of the impedance circuits of the transmit port and the receive port of the UCIe, and has a simple circuit design, and improves design consistency.

Specifically, the input impedance of the receive port and the output impedance of the transmit port are specified as 50 ohms and 30 ohms, respectively, in the specification of the UCIe interface protocol. Therefore, considering design convenience and practicality, the receive port may reuse the impedance circuit design of the transmit port. In addition, because the impedance calibration circuit performs internal impedance calibration by using the external resistor, and the impedance value finally selected for the external resistor is 270 ohms. If the unit impedance is set to 270 ohms, the transmit port may use nine impedance units connected in parallel to implement 30 ohms, but the receive port may only connect five (54 ohms) or six (45 ohms) impedance units in parallel, which easily exceeds the design range specified in the specification. Therefore, the impedance value of each of the impedance units finally selected in the design is equal to 540 ohms, 11 impedance units (540 ohms/11=49 ohms) are selected to be connected in parallel at the receive port, and 18 impedance units (540 ohms/18=30 ohms) are selected to be connected in parallel at the transmit port.

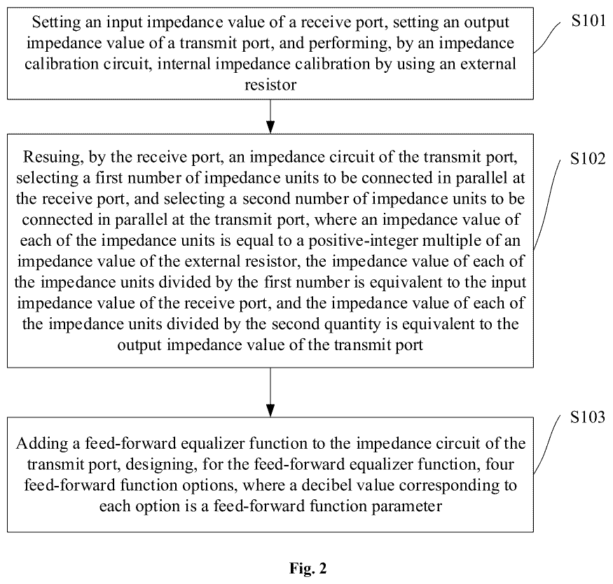

In a specific implementation of some embodiments of the present disclosure, referring to FIG. 2, the method further includes:

Step 103: adding a feed-forward equalizer function to the impedance circuit of the transmit port, designing, for the feed-forward equalizer function, four feed-forward function options, where a decibel value corresponding to each option is a feed-forward function parameter.

The feed-forward equalizer function is implemented based on a change in the output impedance of the transmit port. This means that by adjusting the output impedance of the transmit port, the transmission characteristic of the signal transmitted by the transmit port may be changed, thereby implementing equalization processing on the transmitted signal. Therefore, in this embodiment of the present disclosure, the feed-forward equalizer function is implemented by changing the output impedance of the port circuit. In addition, four feed-forward function options are designed for the feed-forward equalizer function, and a decibel value corresponding to each option is a feed-forward function parameter.

To reduce the influence of partial inter-symbol interference (ISI) and crosstalk (Xtalk) by using the feed-forward equalizer function, in high-speed signal transmission, the inter-symbol interference is caused by frequency selective attenuation of a channel, and the crosstalk is caused by electromagnetic coupling between signal lines. In actual applications, channels of different lengths have different degrees of attenuation and interference on signals. Therefore, different feed-forward equalization coefficients need to be selected according to the channel length to optimize signal quality. After adding the channel parasitic parameter and the post-simulation parasitic of the actual transmit port/receive port circuit, the feed-forward function parameter is selected and set according to channels of different lengths.

When the channel length is 3 mm, the feed-forward function parameter is 1 or 2, and the inter-symbol interference performs best. For the 3 mm channel, the signal attenuation is relatively small. Therefore, a relatively low FFE equalization coefficient (such as 1 or 2) is usually selected. This may effectively compensate for the low-pass characteristic of the channel without introducing excessive high-frequency noise, thereby obtaining the best inter-symbol interference performance.

When the channel length is 15 mm, the feed-forward function parameter is 2 or 3, and the inter-symbol interference performs best. For the 15 mm channel, the signal attenuation and the ISI problem are more significant. Therefore, a higher FFE equalization coefficient (such as 2 or 3) needs to be selected. These coefficients may more effectively enhance the high-frequency component of the signal, thereby better compensating for the channel attenuation.

When the channel length is 25 mm, the feed-forward function parameter is 3 or 4, and the inter-symbol interference performs best. For the 25 mm channel, the signal attenuation and the ISI problem are the most serious. Therefore, the highest FFE equalization coefficient (such as 3 or 4) needs to be selected. These coefficients may provide stronger high-frequency compensation, thereby maintaining the signal integrity in long-distance transmission.

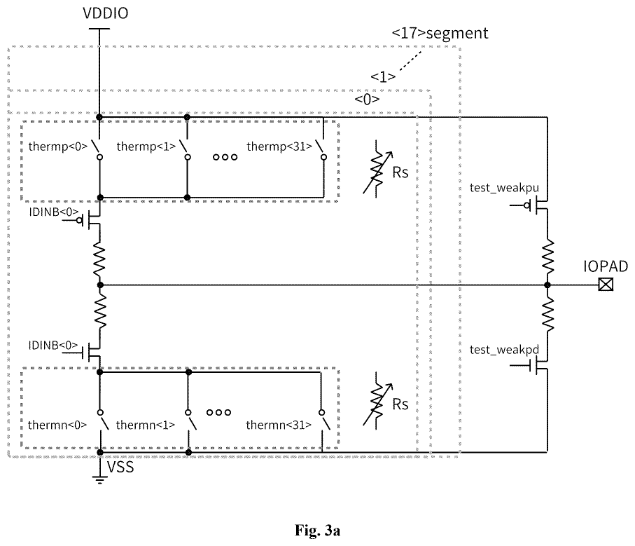

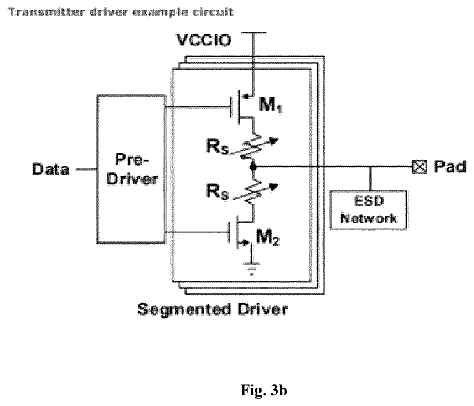

Specifically, FIG. 3a shows an impedance unit structure recommended in the specification of the UCIe, and FIG. 3b shows an actual circuit architecture of the impedance unit structure. The design of the impedance unit in this embodiment of the present disclosure uses a positive 32-bit thermal code signal thermp<31:0> and a negative 32-bit thermal code signal thermn<31:0> to adjust the resistance value, where the positive 32-bit thermal code signal thermp<31:0> is a 32-bit thermal code positive signal in which each bit signal is independently controlled, and the negative 32-bit thermal code signal thermn<31:0> is a 32-bit thermal code negative signal in which each bit signal is independently controlled. In this embodiment of the present disclosure, the thermal code signals (thermp<31:0> and thermn<31:0>) are used to adjust the resistance value of the unit impedance, to implement the part of the adjustable impedance (Rs) exemplified in the specification, thereby implementing fine adjustment on the adjustable impedance to ensure that the adjustable impedance meets the design specification and optimize the signal transmission performance.

The feed-forward equalizer function in this embodiment of the present disclosure is configured to set the pull-up impedance unit or the pull-down impedance unit. The pull-up impedance unit or the pull-down impedance unit includes: an adjustable impedance, a high-speed logic signal drive stage, and a fixed resistor stage. The adjustable impedance controlled by the thermal code signal adjustment bit is a core part of impedance adjustment, and fine adjustment of the impedance is implemented by using the thermal code signal. The high-speed logic signal drive stage is responsible for driving a high-speed signal to ensure fast signal transmission. The fixed resistor stage provides a basic impedance value, which is combined with other parts to implement the final impedance matching.

In an actual process of calibrating the port impedance, a thermal bit is adjusted according to thermal encoding, one bit is changed at a time, and it is ensured that a step size of less than 0.5 ohm may be implemented under different process (P), voltage (V), and temperature (T) conditions, to meet the requirement on an impedance adjustment step size in the specification. This encoding manner may effectively reduce errors and noise in the adjustment process, and improve adjustment precision and stability. This embodiment of the present disclosure meets the requirement on the impedance adjustment step size in the specification, and ensures that accurate impedance matching may be implemented under various working conditions.

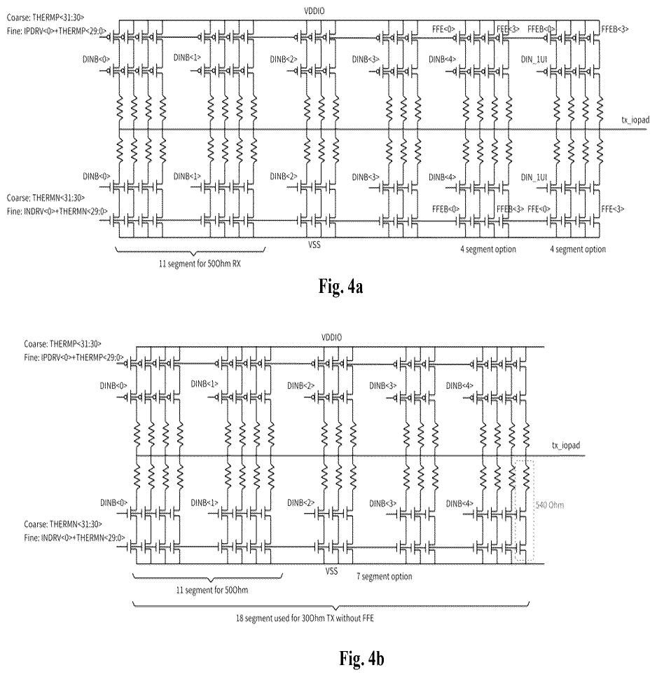

Specifically, port impedance circuit structure diagrams are shown in FIG. 4a and FIG. 4b. FIG. 4a is a diagram of a receive port impedance circuit in which 11 impedance units are connected in parallel, and FIG. 4b is a diagram of a transmit port impedance circuit in which 18 impedance units are connected in parallel.

Further, four impedance units are added to the transmit port to implement a 1-tap feed-forward equalizer function (1-tap FFE). The four impedance units are added to the transmit port to provide an additional signal adjustment capability, to improve the signal transmission characteristic. In particular, in high-speed signal transmission, the 1-tap feed-forward equalizer function may effectively reduce the influence of inter-symbol interference and crosstalk.

When the feed-forward equalizer function is not enabled, the equivalent impedance is shown in the circuit diagram of the transmit port in FIG. 4 b, and a total of 18 units are enabled.

When the feed-forward equalizer function is enabled, 14 of the 22 impedance units of the transmit port are driven by the data input signal DINB<3:0>, four impedance units are driven by the data input signal DINB<4> and a feed-forward equalization control signal FFE<3:0>, and four impedance units are driven by the data input 1 unit interval signal DIN_1UI and the feed-forward equalization control signal FFE<3:0>.

In this embodiment of the present disclosure, by precisely controlling the data input signal, the data input 1 unit interval signal, and the feed-forward equalization control signal, different impedance states may be implemented in different stages, thereby optimizing the signal transmission quality. This design uses the feed-forward equalizer function to improve the signal integrity. In particular, in high-speed signal transmission, the attenuation and distortion of the signal in the transmission process are reduced by using a de-emphasis technology.

Specifically, when the feed-forward equalizer function is enabled:
If FFE=1, FFE<0>=H, FFEB<0>=L, FFE<3:1>=L, and FFEB<3:1>=H;
If FFE=2, FFE<1:0>=H, FFEB<1:0>=L, FFE<3:2>=L, and FFEB<3:2>=H;
If FFE=3, FFE<2:0>=H, FFEB<2:0>=L, FFE<3>=L, and FFEB<3>=H;
If FFE=4, FFE<3:0>=H, and FFEB<3:0>=L;
where FFE is the feed-forward function parameter, FFEB is an inverted signal of FFE, H is a high level, and L is a low level.

The case where FFE=2 is used as an example below.

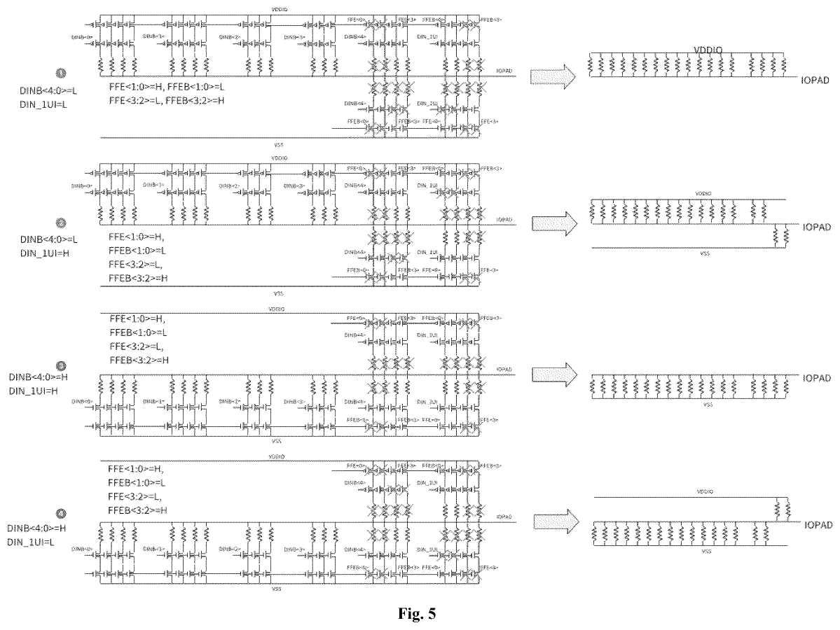

As shown in FIG. 5, when the feed-forward equalizer function is enabled, it is assumed that FFE=2, and therefore FFE<1:0>=H, FFEB<1:0>=L, FFE<3:2>=L, and FFEB<3:2>=H. It may be learned that all P-type metal-oxide-semiconductor (PMOS) transistors driven by FFE<1:0> are disconnected, all N-type metal-oxide-semiconductor (NMOS) transistors driven by FFE<3:2> are disconnected, all NMOS transistors driven by FFEB<1:0> are disconnected, and all PMOS transistors driven by FFEB<3:2> are disconnected. In addition, in four different waveform stages, the equivalent impedance is shown on the right side of FIG. 5.

In the first stage, the data input signal DINB<4:0>=L, and the data input 1 unit interval signal DIN_1UI=L:

The two pull-up branches where FFEB<1:0> is located are controlled to be enabled by the data input 1 unit interval signal DIN_1UI, and the two pull-up branches where FFE<1:0> is located and that are controlled by the data input signal DINB<4> are disconnected, which is equivalent to enabling two pull-up branches controlled by DIN_1UI and disabling two pull-up branches controlled by the data input signal DINB<4>.

In the second stage, the data input signal DINB<4:0>=L, and the data input 1 unit interval signal DIN_1UI=H:

The data input 1 unit interval signal DIN_1UI changes from low to high, which is equivalent to that the two pull-up branches where FFEB<1:0> is located are controlled to be disconnected by the data input 1 unit interval signal DIN_1UI, and the two pull-down branches where FFE<1:0> is located are controlled to be enabled by the data input 1 unit interval signal DIN_1UI, to implement de-emphasis equalization of the transmitted data ‘1’.

In the third stage, the data input signal DINB<4:0>=H, and the data input 1 unit interval signal DIN_1UI=H:

The two pull-down branches where FFE<1:0> is located are controlled to be enabled by the data input 1 unit interval signal DIN_1UI, and the two pull-down branches where FFEB<1:0> is located and that are controlled by the data input signal DINB<4> are disconnected, which is equivalent to enabling two pull-down branches controlled by the data input 1 unit interval signal DIN_1UI and disabling two pull-down branches controlled by the data input signal DINB<4>.

In the fourth stage, the data input signal DINB<4:0>=L, and the data input 1 unit interval signal DIN_1UI=L:

The data input 1 unit interval signal DIN_1UI changes from high to low, which is equivalent to that the two pull-down branches where FFE<1:0> is located are controlled to be disconnected by the data input 1 unit interval signal DIN_1UI, and the two pull-up branches where FFEB<1:0> is located are controlled to be enabled by the data input 1 unit interval signal DIN_1UI, to implement de-emphasis equalization of the transmitted data ‘0’.

The driving control of the data input signal DINB<4:0> and the data input 1 unit interval signal DIN_1UI in this embodiment of the present disclosure is as follows: In the first stage, two pull-up impedance units with the feed-forward function are enabled, and at the same time, two basic pull-up impedance units are disabled. In the third stage, two pull-down impedance units with the feed-forward function are enabled, and at the same time, two basic pull-down impedance units are disabled. In the second and fourth stages in which equalization takes effect, the two pull-up impedance units are changed to the two pull-down impedance units, or the two pull-down impedance units are changed to the two pull-up impedance units.

Therefore, in the four stages, the equivalent impedance from the output node of the input/output pad (IOPAD) of the transmit port to the power ground is unchanged. In the direction of the small-signal equivalent impedance, the impedance from the input/output pad (IOPAD) of the transmit port to the ground in each stage is 18 impedance units connected in parallel, and the 30-ohm impedance of the transmit port may always be kept unchanged. In addition, due to the change in the pull-up and pull-down impedances in the second and fourth stages, the output signal of the input/output pad (IOPAD) has the de-emphasis equalization effect in the second and fourth stages.

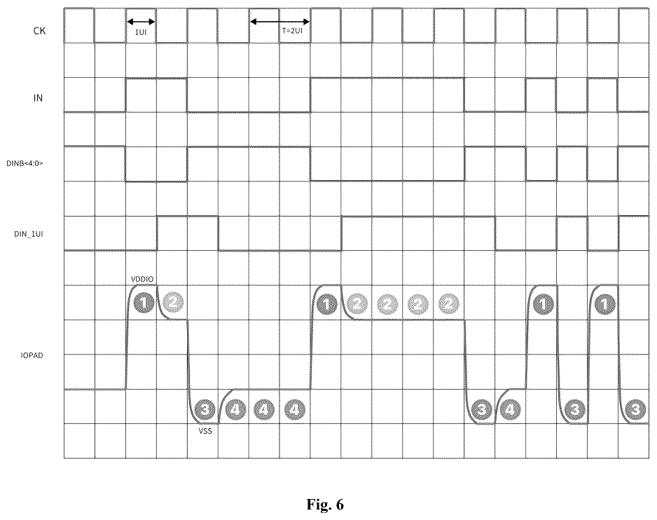

As shown in FIG. 6, to implement the foregoing driving control of the data input signal DINB<4:0> and the data input 1 unit interval signal DIN_1UI, the data input signal DINB<4:0> is inverted from the original input signal IN, and the data input 1 unit interval signal DIN_1UI lags behind the original input signal IN by a half cycle.

In this embodiment of the present disclosure, the data input signal DINB<4:0> and the data input 1 unit interval signal DIN_1UI of the impedance unit are generated by using a clock and input data, and at the same time, the alignment of the rising edge or the falling edge of the data input signal DINB<4:0> and the data input 1 unit interval signal DIN_1UI is ensured. The data input signal DINB<4:0> and the data input 1 unit interval signal DIN_1UI are obtained with first-stage and second-stage circuits that multiplex a half-rate parallel-to-serial conversion logic by multi-stage frequency division and logic processing.

These signals, which are for the first and second stage circuits of a reused half-rate Parallel-to-Serial (PISO) converter logic, are obtained through multi-stage frequency division and logic processing.

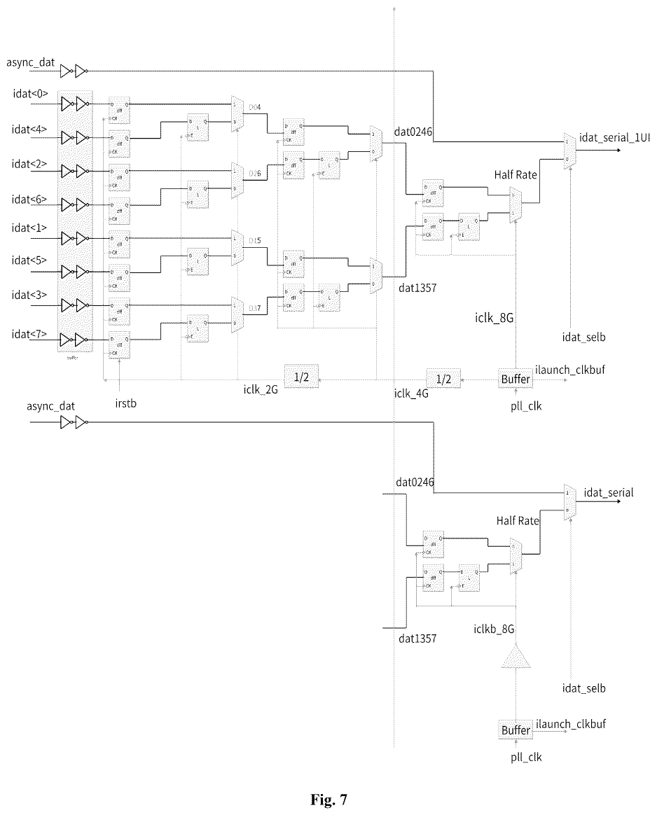

Specifically, referring to FIG. 7, this embodiment of the present disclosure uses pll_clk as the input clock. After passing through a buffer, the input clock is divided by two to generate iclk_4G, and then divided by two to generate iclk_2G. The main body of the overall circuit of the half-rate parallel-to-serial conversion logic is divided into three stages. The first stage is driven by iclk_2G, the second stage is driven by iclk_4G, and the third stage is driven by iclk_8G or iclkb_8G. The first-stage, second-stage, and third-stage circuits may convert eight groups of parallel data (idat<7:0>) into serial data for output.

In this embodiment of the present disclosure, the first-stage and second-stage circuits of the half-rate parallel-to-serial conversion logic are multiplexed, and the 0th, 2nd, 4th, and 6th groups of data (dat0246) and the 1st, 3rd, 5th, and 7th groups of data (dat1357) are used as the original input signals of both the serial main path and the 1 unit interval (1UI) path. In addition to generating the serial data output (idat_serial) signal, a 1 unit interval serial data output (idat_serial_1UI) signal is additionally output separately.

The logic implementation of the data input signal DINB<4:0> and the data input 1 unit interval signal DIN_1UI in this embodiment of the present disclosure includes the first-stage and second-stage circuits that multiplex the half-rate parallel-to-serial conversion logic. Specifically, the data input signal DINB<4:0> and the data input 1 unit interval signal DIN_1UI are generated through a logic element such as a D-type flip-flop (DFF), a latch, a multiplexer (MUX), and the like by using signals such as the 0th, 2nd, 4th, and 6th groups of data (dat0246) and the 1st, 3rd, 5th, and 7th groups of data (dat1357), to implement control on different feed-forward equalizer states of the impedance unit. That is, the synchronous data input signal DINB<4:0> and the synchronous data input 1 unit interval signal DIN_1UI are generated to drive and control the impedance unit, thereby achieving equalization.

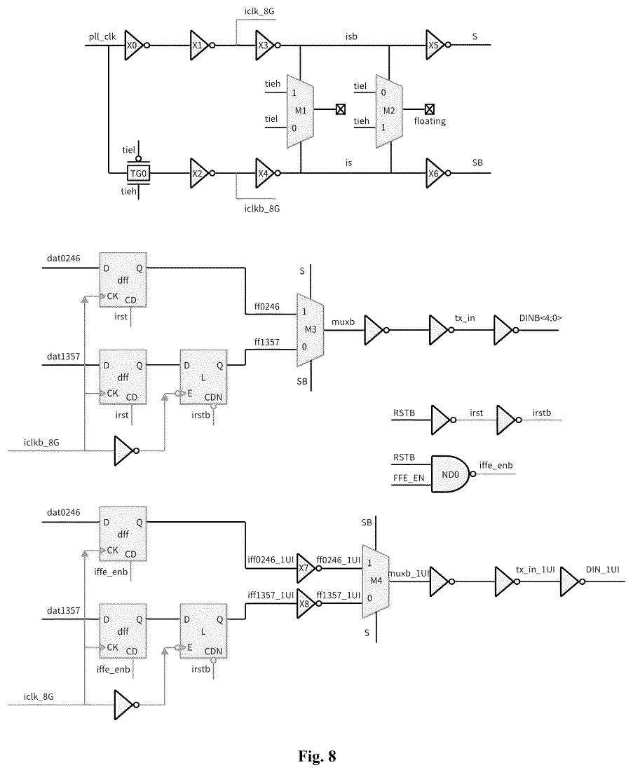

Specifically, the circuit implementation of generating the data input signal and the data input 1 unit interval signal is shown in FIG. 8.

The input clock (pll_clk) is an 8 GHz clock signal. An intermediate clock signal (iclk_8G) is generated by the input clock (pll_clk) through an inverter X0 and an inverter X1, and a signal S is generated through an inverter X3 and an inverter X5. At the same time, an inverted signal (iclkb_8G) is generated by the input clock (pll_clk) through TG0 and an inverter X2, and a signal SB is generated through an inverter X4 and an inverter X6. The transistor TG0 is added to keep a balance of signal delay with the inverter X0. A multiplexer M1 and a multiplexer M2 are added to balance the load between the signal S and a signal isb and the load between the signal SB and a signal is. The inverted signal (iclkb_8G) of the input clock passes through a D-type flip-flop of a high-level active clear signal (CD) controlled by a high-level active reset signal (rst) and a latch of a low-level active clear signal (CDN) controlled by a low-level active reset signal (rstb), to obtain ff0246 and ff1357. After passing through a multiplexer M3 in a half rate and being buffered by two stages of inverters, tx_in is obtained. After re-inverting driving, the data input signal DINB<4:0> is obtained.

The circuit implementation of the 1 unit interval (1UI) path reuses a part of the main path, and control modification is performed by using a feed-forward equalizer (FFE) enable signal. The 8 GHz clock signal (iclk_8G) passes through a D-type flip-flop (DFF) of a high-level active clear signal (CD) controlled by an IFFE enable signal (iffe_enb) and a latch of a low-level active clear signal (CDN) controlled by the low-level active reset signal (rstb), and is inverted to obtain ff0246_1UI and ff1357_1UI. After passing through a multiplexer M4 in the half rate and being buffered by the two stages of inverters, tx_in_1UI is obtained. After re-inverting driving, the data input 1 unit interval signal DIN_1UI is obtained.

In the design circuit of the data input 1 unit interval signal in this embodiment of the present disclosure, elements such as a transistor, an inverter, and a multiplexer are added at the same time to balance the load of front and back nodes, maintain symmetry and driving design consistency, and ensure the stable operation of the circuit at the clock frequency of 8 GHz. For example, the transistor TG0 is added to balance the delay caused by the inverter X0, and the inverter M1 and the inverter M2 are added to balance the load of the signal S and the signal isb and the load of the signal SB and the signal is, to maintain the driving design consistency. The logic generation circuits such as the D-type flip-flop (DFF), the latch, and the multiplexer (MUX) of the 1UI path and the main path also basically remain symmetric. It is also one of the design focuses that an inverter X7 and an inverter X8 are added before the inverter M4 as necessary reverse logic. Multiplexers such as the multiplexer M3 or the multiplexer M4 all operate at a clock frequency of up to 8 GHz, and the subsequent paths all belong to nodes of the highest-rate path, and the signal inversion frequency before the multiplexer M4 is less than 8 GHz, and design verification is relatively simpler.

### Port Circuit

Corresponding to the foregoing method, the present disclosure further provides a port impedance circuit, applied to a UCIe. The port impedance circuit is coupled to a transmit port and a receive port. An impedance calibration circuit of the port impedance circuit performs internal impedance calibration by using an external resistor. The port impedance circuit enables the receive port to reuse an impedance circuit of the transmit port. A first number of impedance units are selected and connected in parallel at the receive port as a receive port impedance circuit, and a second number of the impedance units are selected and connected in parallel at the transmit port as a transmit port impedance circuit. An impedance value of each of the impedance units is equal to a positive integer multiple of an impedance value of the external resistor. The impedance value of each of the impedance units divided by the first number is equivalent to an input impedance value of the receive port, and the impedance value of each of the impedance units divided by the second number is equivalent to an output impedance value of the transmit port.

This embodiment of the present disclosure implements the design of the impedance circuits of the transmit port and the receive port of the UCIe, and the circuit design is simple, and the design consistency is improved.

Specifically, the input impedance of the receive port and the output impedance of the transmit port are specified as 50 ohms and 30 ohms, respectively, in the specification of the UCIe interface protocol. Therefore, considering design convenience and practicality, the receive port may reuse the impedance circuit design of the transmit port. In addition, because the impedance calibration circuit performs internal impedance calibration by using the external resistor, and the impedance value finally selected for the external resistor is 270 ohms. If the unit impedance is set to 270 ohms, the transmit port may use nine impedance units connected in parallel to implement 30 ohms, but the receive port may only connect five (54 ohms) or six (45 ohms) impedance units in parallel, which easily exceeds the design range specified in the specification. Therefore, the impedance value of each of the impedance units finally selected in the design is equal to 540 ohms, 11 impedance units (540 ohms/11=49 ohms) are selected to be connected in parallel at the receive port, and 18 impedance units (540 ohms/18=30 ohms) are selected to be connected in parallel at the transmit port.

In a specific implementation of some embodiments of the present disclosure, the port impedance circuit further adds a feed-forward equalizer function to the impedance circuit of the transmit port, designs, for the feed-forward equalizer function, four feed-forward function options, where a decibel value corresponding to each option is a feed-forward function parameter.

The feed-forward equalizer function is implemented based on a change in the output impedance of the transmit port. This means that by adjusting the output impedance of the transmit port, the transmission characteristic of the signal transmitted by the transmit port may be changed, thereby implementing equalization processing on the transmitted signal. Therefore, in this embodiment of the present disclosure, the feed-forward equalizer function is implemented by changing the output impedance of the port circuit. In addition, four feed-forward function options are designed for the feed-forward equalizer function, and a decibel value corresponding to each option is a feed-forward function parameter.

To reduce the influence of partial inter-symbol interference (ISI) and crosstalk (Xtalk) by using the feed-forward equalizer function, in high-speed signal transmission, the inter-symbol interference is caused by frequency selective attenuation of a channel, and the crosstalk is caused by electromagnetic coupling between signal lines. In actual applications, channels of different lengths have different degrees of attenuation and interference on signals. Therefore, different feed-forward equalization coefficients need to be selected according to the channel length to optimize signal quality. After adding the channel parasitic parameter and the post-simulation parasitic of the actual transmit port/receive port circuit, the feed-forward function parameter is selected and set according to channels of different lengths.

When the channel length is 3 mm, the feed-forward function parameter is 1 or 2, and the intersymbol interference performs best. For the 3 mm channel, the signal attenuation is relatively small. Therefore, a relatively low FFE equalization coefficient (such as 1 or 2) is usually selected. This may effectively compensate for the low-pass characteristic of the channel without introducing excessive high-frequency noise, thereby obtaining the best inter-symbol interference performance.

When the channel length is 15 mm, the feed-forward function parameter is 2 or 3, and the inter-symbol interference performs best. For the 15 mm channel, the signal attenuation and the ISI problem are more significant. Therefore, a higher FFE equalization coefficient (such as 2 or 3) needs to be selected. These coefficients may more effectively enhance the high-frequency component of the signal, thereby better compensating for the channel attenuation.

When the channel length is 25 mm, the feed-forward function parameter is 3 or 4, and the inter-symbol interference performs best. For the 25 mm channel, the signal attenuation and the ISI problem are the most serious. Therefore, the highest FFE equalization coefficient (such as 3 or 4) needs to be selected. These coefficients may provide stronger high-frequency compensation, thereby maintaining the signal integrity in long-distance transmission.

Specifically, FIG. 3a shows an impedance unit structure recommended in the specification of the UCIe, and FIG. 3b shows an actual circuit architecture of the impedance unit structure. The design of the impedance unit in this embodiment of the present disclosure uses a positive 32-bit thermal code signal thermp<31:0> and a negative 32-bit thermal code signal thermn<31:0> to adjust the resistance value, where the positive 32-bit thermal code signal thermp<31:0> is a 32-bit thermal code positive signal in which each bit signal is independently controlled, and the negative 32-bit thermal code signal thermn<31:0> is a 32-bit thermal code negative signal in which each bit signal is independently controlled. In this embodiment of the present disclosure, the thermal code signals (thermp<31:0> and thermn<31:0>) are used to adjust the resistance value of the unit impedance, to implement the part of the adjustable impedance (Rs) exemplified in the specification, thereby implementing fine adjustment on the adjustable impedance to ensure that the adjustable impedance meets the design specification and optimize the signal transmission performance.

The feed-forward equalizer function in this embodiment of the present disclosure is configured to set the pull-up impedance unit or the pull-down impedance unit. The pull-up impedance unit or the pull-down impedance unit includes: an adjustable impedance, a high-speed logic signal drive stage, and a fixed resistor stage. The adjustable impedance controlled by the thermal code signal adjustment bit is a core part of impedance adjustment, and fine adjustment of the impedance is implemented by using the thermal code signal. The high-speed logic signal drive stage is responsible for driving a high-speed signal to ensure fast signal transmission. The fixed resistor stage provides a basic impedance value, which is combined with other parts to implement the final impedance matching.

In an actual process of calibrating the port impedance, a thermal bit is adjusted according to thermal encoding, one bit is changed at a time, and it is ensured that a step size of less than 0.5 ohm may be implemented under different process (P), voltage (V), and temperature (T) conditions, to meet the requirement on an impedance adjustment step size in the specification. This encoding manner may effectively reduce errors and noise in the adjustment process, and improve adjustment precision and stability. This embodiment of the present disclosure meets the requirement on the impedance adjustment step size in the specification, and ensures that accurate impedance matching may be implemented under various working conditions.

Specifically, the port impedance circuit structure diagrams are shown in FIG. 4. Four impedance units are added to the transmit port to implement a 1-tap feed-forward equalizer function (1-tap FFE). The four impedance units are added to the transmit port to provide an additional signal adjustment capability, to improve the signal transmission characteristic. In particular, in high-speed signal transmission, the 1-tap feed-forward equalizer function may effectively reduce the influence of intersymbol interference and crosstalk.

When the feed-forward equalizer function is not enabled, the equivalent impedance is shown in the circuit diagram of the lower transmit port in FIG. 4, and a total of 18 units are enabled. When the feed-forward equalizer function is enabled, 14 of the 22 impedance units of the transmit port are driven by the data input signal DINB<3:0>, four impedance units are driven by the data input signal DINB<4> and a feed-forward equalization control signal FFE<3:0>, and four impedance units are driven by the data input 1 unit interval signal DIN_1UI and the feed-forward equalization control signal FFE<3:0>.

In this embodiment of the present disclosure, by precisely controlling the data input signal, the data input 1 unit interval signal, and the feed-forward equalization control signal, different impedance states may be implemented in different stages, thereby optimizing the signal transmission quality. This design uses the feed-forward equalizer function to improve the signal integrity. In particular, in high-speed signal transmission, the attenuation and distortion of the signal in the transmission process are reduced by using a de-emphasis technology.

Specifically, when the feed-forward equalizer function is enabled:
If FFE=1, FFE<0>=H, FFEB<0>=L, FFE<3:1>=L, and FFEB<3:1>=H;
If FFE=2, FFE<1:0>=H, FFEB<1:0>=L, FFE<3:2>=L, and FFEB<3:2>=H;
If FFE=3, FFE<2:0>=H, FFEB<2:0>=L, FFE<3>=L, and FFEB<3>=H;
If FFE=4, FFE<3:0>=H, and FFEB<3:0>=L;
where FFE is the feed-forward function parameter, FFEB is an inverted signal of FFE, H is a high level, and L is a low level.

The case where FFE=2 is used as an example below.

As shown in FIG. 5, when the FFE function is enabled, it is assumed that FFE=2, and therefore FFE<1:0>=H, FFEB<1:0>=L, FFE<3:2>=L, and FFEB<3:2>=H. It may be learned that all P-type metal-oxide-semiconductor (PMOS) transistors driven by FFE<1:0> are disconnected, all N-type metal-oxide-semiconductor (NMOS) transistors driven by FFE<3:2> are disconnected, all NMOS transistors driven by FFEB<1:0> are disconnected, and all PMOS transistors driven by FFEB<3:2> are disconnected. In addition, in four different waveform stages, the equivalent impedance is shown on the right side of FIG. 5.

In the first stage, the data input signal DINB<4:0>=L, and the data input 1 unit interval signal DIN_1UI=L:

The two pull-up branches where FFEB<1:0> is located are controlled to be enabled by the data input 1 unit interval signal DIN_1UI, and the two pull-up branches where FFE<1:0> is located and that are controlled by the data input signal DINB<4> are disconnected, which is equivalent to enabling two pull-up branches controlled by DIN_1UI and disabling two pull-up branches controlled by the data input signal DINB<4>.

In the second stage, the data input signal DINB<4:0>=L, and the data input 1 unit interval signal DIN_1UI=H:

The data input 1 unit interval signal DIN_1UI changes from low to high, which is equivalent to that the two pull-up branches where FFEB<1:0> is located are controlled to be disconnected by the data input 1 unit interval signal DIN_1UI, and the two pull-down branches where FFE<1:0> is located are controlled to be enabled by the data input 1 unit interval signal DIN_1UI, to implement de-emphasis equalization of the transmitted data ‘1’.

In the third stage, the data input signal DINB<4:0>=H, and the data input 1 unit interval signal DIN_1UI=H:

The two pull-down branches where FFE<1:0> is located are controlled to be enabled by the data input 1 unit interval signal DIN_1UI, and the two pull-down branches where FFEB<1:0> is located and that are controlled by the data input signal DINB<4> are disconnected, which is equivalent to enabling two pull-down branches controlled by the data input 1 unit interval signal DIN_1UI and disabling two pull-down branches controlled by the data input signal DINB<4>.

In the fourth stage, the data input signal DINB<4:0>=L, and the data input 1 unit interval signal DIN_1UI=L:

The data input 1 unit interval signal DIN_1UI changes from high to low, which is equivalent to that the two pull-down branches where FFE<1:0> is located are controlled to be disconnected by the data input 1 unit interval signal DIN_1UI, and the two pull-up branches where FFEB<1:0> is located are controlled to be enabled by the data input 1 unit interval signal DIN_1UI, to implement de-emphasis equalization of the transmitted data ‘0’.

The driving control of the data input signal DINB<4:0> and the data input 1 unit interval signal DIN_1UI in this embodiment of the present disclosure is as follows: In the first stage, two pull-up impedance units with the feed-forward function are enabled, and at the same time, two basic pull-up impedance units are disabled. In the third stage, two pull-down impedance units with the feed-forward function are enabled, and at the same time, two basic pull-down impedance units are disabled. In the second and fourth stages in which equalization takes effect, the two pull-up impedance units are changed to the two pull-down impedance units, or the two pull-down impedance units are changed to the two pull-up impedance units.

Therefore, in the four stages, the equivalent impedance from the output node of the input/output pad (IOPAD) of the transmit port to the power ground is unchanged. In the direction of the small-signal equivalent impedance, the impedance from the input/output pad (IOPAD) of the transmit port to the ground in each stage is 18 impedance units connected in parallel, and the 30-ohm impedance of the transmit port may always be kept unchanged. In addition, due to the change in the pull-up and pull-down impedances in the second and fourth stages, the output signal of the input/output pad (IOPAD) has the de-emphasis equalization effect in the second and fourth stages.

As shown in FIG. 6, to implement the foregoing driving control of the data input signal DINB<4:0> and the data input 1 unit interval signal DIN_1UI, the data input signal DINB<4:0> is inverted from the original input signal, and the data input 1 unit interval signal DIN_1UI lags behind the original input signal by a half cycle.

In this embodiment of the present disclosure, the data input signal DINB<4:0> and the data input 1 unit interval signal DIN_1UI of the impedance unit are generated by using the clock and the input data, and at the same time, the consistency of the rising edge or the falling edge of the data input signal DINB<4:0> and the data input 1 unit interval signal DIN_1UI is ensured. The data input signal DINB<4:0> and the data input 1 unit interval signal DIN_1UI are first-stage and second-stage circuits that multiplex half-rate parallel-to-serial conversion logic, and are obtained through multi-stage frequency division and logic processing.

Specifically, referring to FIG. 7, this embodiment of the present disclosure uses pll_clk as the input clock. After passing through a buffer, the input clock is divided by two to generate iclk_4G, and then divided by two to generate iclk_2G. The main body of the overall circuit of the half-rate parallel-to-serial conversion logic is divided into three stages. The first stage is driven by iclk_2G, the second stage is driven by iclk_4G, and the third stage is driven by iclk_8G or iclkb_8G. The first-stage, second-stage, and third-stage circuits may convert eight groups of parallel data (idat<7:0>) into serial data for output.

In this embodiment of the present disclosure, the first-stage and second-stage circuits of the half-rate parallel-to-serial conversion logic are multiplexed, and the 0th, 2nd, 4th, and 6th groups of data (dat0246) and the 1st, 3rd, 5th, and 7th groups of data (dat1357) are used as the original input signals of both the serial main path and the 1 unit interval (1UI) path. In addition to generating the serial data output (idat_serial) signal, a 1 unit interval serial data output (idat_serial_1UI) signal is additionally output separately.

The logic implementation of the data input signal DINB<4:0> and the data input 1 unit interval signal DIN_1UI in this embodiment of the present disclosure is the first-stage and second-stage circuits that multiplex the half-rate parallel-to-serial conversion logic. Specifically, the data input signal DINB<4:0> and the data input 1 unit interval signal DIN_1UI are generated through logic of a D-type flip-flop (DFF), a latch, a multiplexer (MUX), and the like by using signals such as the 0th, 2nd, 4th, and 6th groups of data (dat0246) and the 1st, 3rd, 5th, and 7th groups of data (dat1357), to implement control on different feed-forward equalizer states of the impedance unit. That is, the synchronous data input signal DINB<4:0> and the synchronous data input 1 unit interval signal DIN_1UI are generated to drive and control the impedance unit, to implement equalization.

Specifically, the circuit implementation of generating the data input signal and the data input 1 unit interval signal is shown in FIG. 8.

The input clock pll_clk is an 8 GHz clock signal. An intermediate clock signal (iclk_8G) is generated by the input clock pll_clk through an inverter X0 and an inverter X1, and a signal S is generated through an inverter X3 and an inverter X5. At the same time, an inverted signal (iclkb_8G) is generated by the input clock pll_clk through TG0 and an inverter X2, and a signal SB is generated through an inverter X4 and an inverter X6. The transistor TG0 is added to keep a balance of signal delay with the inverter X0. A multiplexer M1 and a multiplexer M2 are added to balance the load between the signal S and a signal isb and the load between the signal SB and a signal is. The inverted signal (iclkb_8G) of the input clock passes through a D-type flip-flop of a high-level active clear signal (CD) controlled by a high-level active reset signal (rst) and a latch of a low-level active clear signal (CDN) controlled by a low-level active reset signal (rstb), to obtain ff0246 and ff1357. After passing through a multiplexer M3 in a half rate and being buffered by two stages of inverters, tx_in is obtained. After re-inverting driving, the data input signal DINB<4:0> is obtained.

The circuit implementation of the 1 unit interval (1UI) path reuses a part of the main path, and control modification is performed by using a feed-forward equalizer (FFE) enable signal. The 8 GHz clock signal (iclk_8G) passes through a D-type flip-flop (DFF) of a high-level active clear signal (CD) controlled by an IFFE enable signal (iffe_enb) and a latch of a low-level active clear signal (CDN) controlled by the low-level active reset signal (rstb), and is inverted to obtain ff0246_1UI and ff1357_1UI. After passing through a multiplexer M4 in the half rate and being buffered by the two stages of inverters, tx_in_1UI is obtained. After re-inverting driving, the data input 1 unit interval signal DIN_1UI is obtained.

In the design circuit of the data input 1 unit interval signal in this embodiment of the present disclosure, elements such as a transistor, an inverter, and a multiplexer are added at the same time to balance the load of front and back nodes, maintain symmetry and driving design consistency, and ensure the stable operation of the circuit at the clock frequency of 8 GHz. For example, the transistor TG0 is added to balance the delay caused by the inverter X0, and the inverter M1 and the inverter M2 are added to balance the load of the signal S and the signal isb and the load of the signal SB and the signal is, to maintain the driving design consistency. The logic generation circuits such as the D-type flip-flop (DFF), the latch, and the multiplexer (MUX) of the 1UI path and the main path also basically remain symmetric. It is also one of the design focuses that an inverter X7 and an inverter X8 are added before the inverter M4 as necessary reverse logic. Multiplexers such as the multiplexer M3 or the multiplexer M4 all operate at a clock frequency of up to 8 GHz, and the subsequent paths all belong to nodes of the highest-rate path, and the signal inversion frequency before the multiplexer M4 is less than 8 GHz, and design verification is relatively simpler.

### System

Corresponding to the foregoing method, the present disclosure further provides a system, including the port impedance circuit in the foregoing embodiments and a chip. A transmit port and a receive port of the chip are coupled to the port impedance circuit.

The embodiments of the present disclosure implement the design of the impedance circuits of the transmit port and the receive port of the UCIe, and the circuit design is simple, and the design consistency is improved.

It should be noted that details of the timestamp synchronization method are described in detail in the timestamp synchronization apparatus part in the foregoing embodiments with reference to the structure schematic diagrams, and for the specific process, reference may be made to the description in the foregoing embodiments of the timestamp synchronization apparatus, and details are not described herein again.

It should be understood that the embodiments in this specification are all described in a progressive manner, and the same or similar parts between the embodiments may be referred to each other, and each embodiment focuses on the differences from other embodiments. In particular, the method embodiment is relatively briefly described because it is basically similar to the method described in the apparatus and system embodiments, and for related parts, reference may be made to part of the description of other embodiments.

It should be understood that the foregoing describes specific embodiments of this specification. Other embodiments are within the scope of the claims. In some cases, the actions or steps recited in the claims may be performed in an order different from that in the embodiments and still achieve desired results. In addition, the process depicted in the drawings does not necessarily require a specific order shown or a sequential order to achieve desired results. In some implementations, multitasking and parallel processing are also possible or may be advantageous.

It should be understood that an element described herein in a singular form or shown as only one in the drawings does not represent that the number of the element is limited to one. In addition, the modules or elements described or shown as separate herein may be combined into a single module or element, and the module or element described or shown as a single herein may be divided into a plurality of modules or elements.

It should also be understood that the terms and expressions used herein are only for description, and one or more embodiments of this specification should not be limited to these terms and expressions. The use of these terms and expressions does not mean excluding any equivalent features of the illustrated and described (or part thereof), and it should be recognized that various modifications that may exist should also be included in the scope of the claims. Other modifications, variations, and substitutions may also exist. Correspondingly, the claims should be considered as covering all these equivalents.

1. A method for designing a port impedance circuit, the port impedance circuit being applied to a Universal Chiplet Interconnect Express (UCIe), wherein the method comprises:
setting an input impedance value of a receive port, setting an output impedance value of a transmit port, and performing, by an impedance calibration circuit of the port impedance circuit, internal impedance calibration by using an external resistor; and
reusing, by the receive port, an impedance circuit of the transmit port, selecting a first number of impedance units to be connected in parallel at the receive port, and selecting a second number of the impedance units to be connected in parallel at the transmit port, wherein an impedance value of each of the impedance units is equal to a positive-integer multiple of an impedance value of the external resistor, the impedance value of each of the impedance units divided by the first number is equivalent to the input impedance value of the receive port, and the impedance value of each of the impedance units divided by the second number is equivalent to the output impedance value of the transmit port.

2. The method of claim 1, wherein the impedance value of each of the impedance units is equal to 2 times the impedance value of the external resistor, the external resistor is 270 ohms, the input impedance value of the receive port is 50 ohms, the output impedance value of the transmit port is 30 ohms, the first number is 11, and the second number is 18.

3. The method of claim 2, wherein the method further comprises:
adding a feed-forward equalizer function to the impedance circuit of the transmit port, designing, for the feed-forward equalizer function, four feed-forward function options, wherein a decibel value corresponding to each option is a feed-forward function parameter.

4. The method of claim 3, wherein the feed-forward function parameter is selected and set according to channels of different lengths;
when a channel length is 3 millimeters, the feed-forward function parameter is 1 or 2;
when the channel length is 15 millimeters, the feed-forward function parameter is 2 or 3; and
when the channel length is 25 millimeters, the feed-forward function parameter is 3 or 4.

5. The method of claim 4, wherein a design of the impedance unit uses a positive 32-bit thermal code signal and a negative 32-bit thermal code signal to adjust a resistance value, wherein the thermal code signal is a thermal code signal in which each bit signal is independently controlled.

6. The method of claim 5, wherein the feed-forward equalizer function is configured to set a pull-up impedance unit or a pull-down impedance unit, wherein the pull-up impedance unit or the pull-down impedance unit comprises: an adjustable impedance, a high-speed logic signal drive stage, and a fixed resistor stage, wherein the adjustable impedance is controlled by a thermal code signal adjustment bit.

7. The method of claim 6, wherein in a process of calibrating the pull-up impedance unit or the pull-down impedance unit, the thermal code signal adjustment bit is adjusted according to thermal encoding, and one bit is changed every time.

8. The method of claim 7, wherein 4 impedance units are added to the transmit port to implement a 1-tap feed-forward equalizer function.

9. The method of claim 8, wherein 14 of 22 impedance units of the transmit port are driven by the data input signal, 4 impedance units are driven by the data input signal and a feed-forward equalization control signal, and 4 impedance units are driven by the data input 1 unit interval signal and the feed-forward equalization control signal.

10. The method of claim 9, wherein in a first stage of the feed-forward equalizer function, two pull-up impedance units of the feed-forward equalizer function are enabled, and at the same time, two basic pull-up impedance units are disabled; in a third stage of the feed-forward equalizer function, two pull-down impedance units with the feed-forward function are enabled, and at the same time, two basic pull-down impedance units are disabled; and in second and fourth stages of the feed-forward equalizer function, the two pull-up impedance units are changed to the two pull-down impedance units, or the two pull-down impedance units are changed to the two pull-up impedance units.

11. The method of claim 10, wherein the data input signal is inverted from an original input signal, the data input 1 unit interval signal lags the original input signal by a half cycle, and rising edges or falling edges of the data input signal and the data input 1 unit interval signal are consistent.

12. The method of claim 11, wherein the data input signal and the data input 1 unit interval signal are obtained by multiplexing first-stage and second-stage circuits of half-rate parallel-to-serial conversion logic.

13. The method of claim 12, wherein a generation circuit of the data input signal and the data input 1 unit interval signal is a symmetric circuit with balanced front and back node loads.

14. A port impedance circuit, applied to a Universal Chiplet Interconnect Express (UCIe), wherein the port impedance circuit is coupled to a transmit port and a receive port; an impedance calibration circuit of the port impedance circuit performs internal impedance calibration by using an external resistor; and the port impedance circuit enables the receive port to reuse an impedance circuit of the transmit port, selects a first number of impedance units to be connected in parallel at the receive port as a receive port impedance circuit, and selects a second number of the impedance units to be connected in parallel at the transmit port as a transmit port impedance circuit, wherein an impedance value of each of the impedance units is equal to a positive-integer multiple of an impedance value of the external resistor, the impedance value of each of the impedance units divided by the first number is equivalent to an input impedance value of the receive port, and the impedance value of each of the impedance units divided by the second number is equivalent to an output impedance value of the transmit port.

15. A system, comprising the port impedance circuit of claim 14 and a chip, wherein a transmit port and a receive port of the chip are coupled to the port impedance circuit.
